(19) United States
(12) Patent Application Publication
(10) Pub. No.: US 2007/0114111 A1
(43) Pub. Date: May 24, 2007

(54) CASSETTE AND MECHANICAL ARM AND PROCESS APPARUTUS

(76) Inventor: Ta-Yu Liu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,538

(22) Filed: Nov. 29, 2005

(30) Foreign Application Priority Data
Nov. 24, 2005 (TW) 94141247

(51) Int. Cl. B65G 13/02

(52) U.S. Cl. 198/780; 414/935

(57) ABSTRACT

A cassette suitable for placing at least one substrate provided. The cassette includes a case and at least a conveying unit. The conveying unit is disposed inside the case and comprises a plurality of rollers for bearing the substrate and at least a magnetic lead pole. Wherein, the magnetic lead pole is electrically connected to one of the rollers, and rotation of a corresponding roller is driven to move the substrate when the magnetic lead pole rotates. In addition, the present invention also discloses a mechanical arm and a process apparatus.

### BACKGROUND OF THE INVENTION

1. Field of Invention

The present invention relates to a cassette, a mechanical arm and a process apparatus. More particularly, the present invention relates to a cassette, a mechanical arm and a process apparatus that utilize the magnetic lead poles.

2. Description of Related Art

The thin film transistor liquid crystal display (TFT-LCD) plays an important role in the display marketplace nowadays, and it mainly comprises a liquid crystal display (LCD) panel, a back light module. The LCD panel is mainly composed of a color filter (CF) substrate, a thin film transistor (TFT) array substrate and a liquid crystal (LC) layer disposed between the CF substrate and the TFT array substrate. Here, the TFT array substrate is manufactured by performing multiple fabricating processes to form a plurality of thin film transistors (TFTs) arranged in matrix on the glass substrate for driving the LC layer.

FIG. 1 schematically shows a traditional cassette for placing substrates, and FIGS. 2A and 2B schematically show a traditional two-fork mechanism arm and removing of substrates out of the cassette, respectively. FIG. 3 schematically shows a loading/unloading chamber of a traditional process apparatus. Refer to FIGS. 1, 2A and 2B first. In general, the substrates S are placed in the cassette 100 in the fabricating process. Wherein, the cassette 100 comprises multiple side-bearing arms 110 disposed on opposite sides in the cassette 100 for bearing the substrate S. For simplicity, only one substrate S and the corresponding side-bearing arms 110 are shown in FIG. 1. In the traditional cassette 100, the size of the side-bearing arms 110 cannot be too large so that the substrates S can be moved in or out of the cassette 100 using the mechanical arm 120, and those side-bearing arms 110 result in difficulties in the positioning of the mechanical arm 120. Additionally, due to increasingly larger sizes of the glass substrates, the side-bearing arms 110 and the glass substrates S would tend to deform.

Afterwards, the two-fork mechanical arm 120 extends to the bottom the substrate S and raises it. Later, the mechanical arm 120 that holds the substrate S withdraws out of the cassette 100 as shown in FIG. 2B, and it moves the substrate S into the process apparatus 200 (shown in FIG. 3). Likewise, with larger sizes of the glass substrates, a stronger structure intensity of the mechanical arm 120 is required to avoid the deformation of the mechanical arm 120 itself.

In FIG. 3, a process apparatus 200 includes a loading/unloading chamber 210 and a reaction chamber 220 connected with the loading/unloading chamber 210. Wherein, a plurality of bearing pins are disposed inside the loading/unloading chamber 210 for bearing the substrate S which is from the cassette 100 and conveyed by the mechanical arm 120. The substrate S is sent into the reaction chamber 220 of the process apparatus 200 for executing the semiconductor processes required. After the semiconductor processes are completed, the substrate S is held again by the mechanical arm 120 and is sent back to the cassette 100.

It's worthy to note that the aforementioned bearing pins 212 used for bearing the substrate S needs to be designed properly, allowing the mechanical arm 120 to move in or out the substrate S. However, an improper design of the locations of the bearing pins 212 causes the difficulties in the poisoning of the mechanical arm 120. Furthermore, when the bearing pins 212 get in touch with the substrate S, the electro-static discharge may appear between them, thereby damaging the electronic devices on the substrate S.

### SUMMARY OF THE INVENTION

In view of this, one object of the present invention is to provide a cassette for improving the deformation of the side-bearing arms and the substrates in the traditional cassette.

Another object of the present invention is to provide a mechanical arm for improving the difficulties in the positioning of the traditional mechanical arm.

One another object of the present invention is to provide a process apparatus for improving the damages of the electronic devices on the substrate caused by the electro-static discharge.

Based on above-mentioned object or others, the present invention provides a cassette suitable for placing at least one substrate. The cassette comprises a case and at least a conveying unit. The conveying unit is disposed inside the case and comprises a plurality of rollers for bearing the substrate and at least a magnetic lead pole. Wherein, the magnetic lead pole is electrically connected to one of the rollers, and rotation of a corresponding roller is driven to move the substrate when the magnetic lead pole rotates.

According to one embodiment of the present invention, the magnetic lead pole is disposed in one end of the corresponding roller.

According to one embodiment of the present invention, the magnetic lead pole is perpendicular to the corresponding roller.

According to one embodiment of the present invention, the rollers are disposed in parallel.

Based on the above-mentioned object or others, the present invention provides a mechanical arm suitable for conveying a substrate. The mechanical arm comprises a main body and a conveying unit. The conveying unit is connected with the main body and comprises a plurality of rollers for bearing the substrate and at least a magnetic lead pole. Wherein, the magnetic lead pole is electrically connected to one of the rollers, and rotation of a corresponding roller is driven to move the substrate when the magnetic lead pole rotates.

According to one embodiment of the present invention, the magnetic lead pole is disposed in one end of the corresponding roller.

According to one embodiment of the present invention, the magnetic lead pole is perpendicular to the corresponding roller.

According to one embodiment of the present invention, the rollers are disposed in parallel.

Based on the above-mentioned object or others, the present invention provides a process apparatus suitable for providing a semiconductor process of a substrate. The process apparatus comprises a reaction chamber, a loading/unloading chamber and a conveying unit. The loading/unloading chamber is connected with the reaction chamber, and the conveying unit is disposed inside the loading/unloading chamber. Wherein, the magnetic lead pole is electrically connected to one of the rollers, and rotation of a corresponding roller is driven to move the substrate when the magnetic lead pole rotates.

According to one embodiment of the present invention, the magnetic lead pole is disposed in one end of the corresponding roller.

According to one embodiment of the present invention, the magnetic lead pole is perpendicular to the corresponding roller.

According to one embodiment of the present invention, the rollers are disposed in parallel.

Based on the descriptions above, because the cassette according to the present invention utilizes the conveying unit composed of the rollers and magnetic lead pole for bearing and conveying the substrates, the deformation of the substrates can be improved, and the difficulties in positioning of the mechanical arm can be decreased. Besides, according to the present invention, the designing of the loading/unloading chamber of the process apparatus can be simplified, and the damages of electronic devices caused by electro-static discharge can be avoided.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a traditional cassette for placing substrates.

FIGS. 2A and 2B schematically show a traditional two-fork mechanism arm and removing of substrates out of the cassette, respectively.

FIG. 3 schematically shows a loading/unloading chamber of a traditional process apparatus.

FIGS. 4A and 4B schematically show a top view and a side view of a cassette according to an embodiment of the present invention, respectively.

FIGS. 5A and 5B schematically show a top view and a three-dimensional view of a mechanical arm according to an embodiment of the present invention, respectively.

FIG. 6A schematically shows a top view a process apparatus according to an embodiment of the present invention, and FIG. 6B schematically shows the usage of the cassette, the mechanical arm and the process apparatus according to the embodiments of the present invention simultaneously.

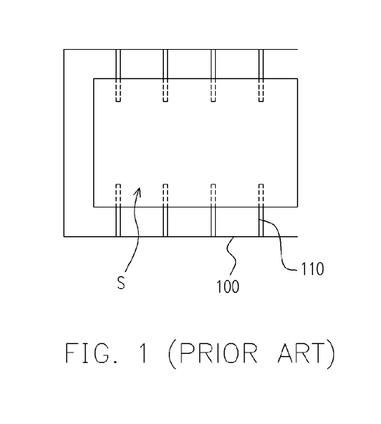

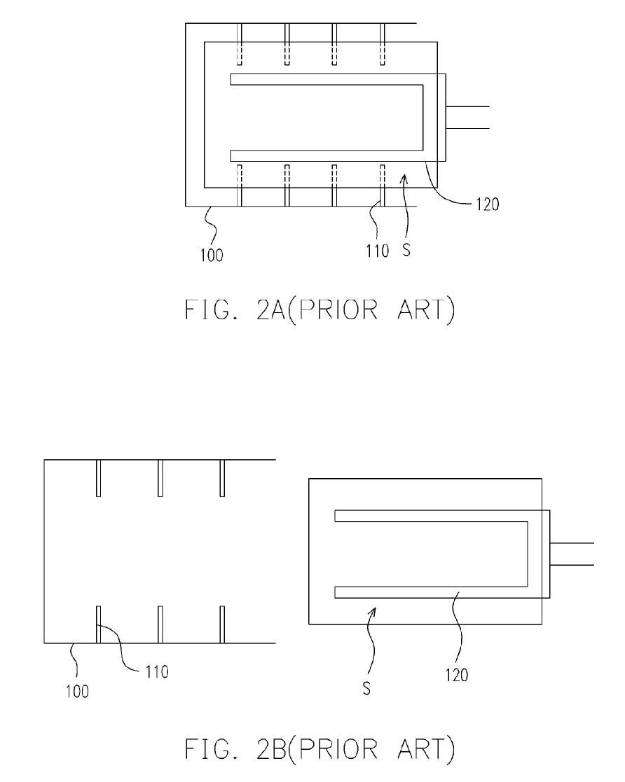

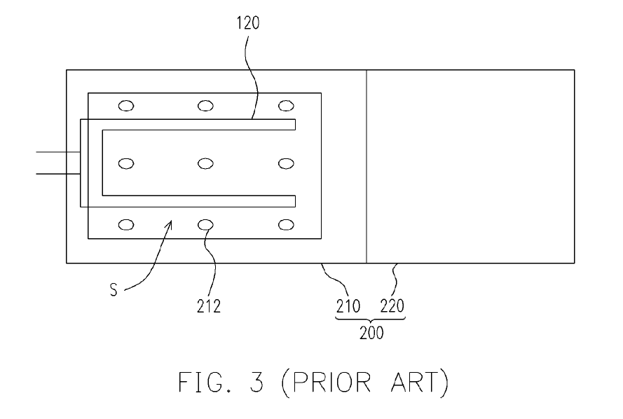

### DESCRIPTION OF THE PREFERRED EMBODIMENTS

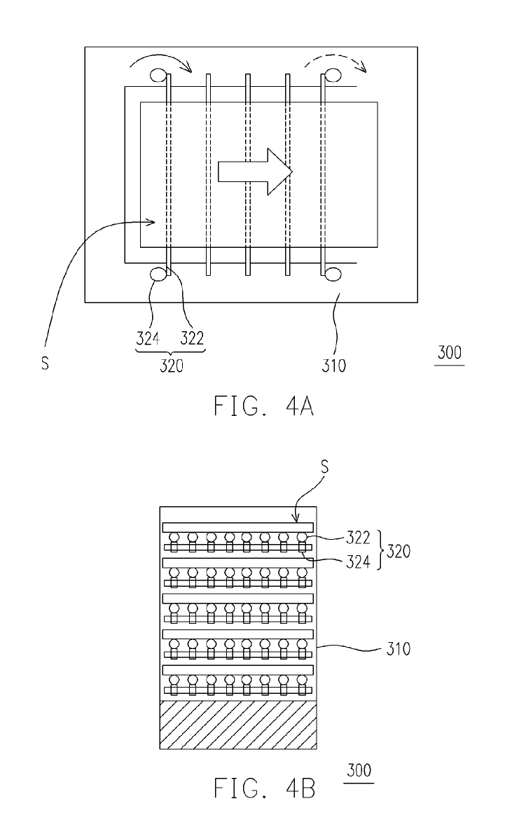

FIGS. 4A and 4B schematically show a top view and a side view of a cassette according to an embodiment of the present invention, respectively. Referring to FIGS. 4A and 4B, in a semiconductor process, a substrate S to be processed or processed already can be placed in a cassette 300 shown in FIG. 4A. This cassette 300 includes a case 310 and a conveying unit 320. The conveying unit 320 is located in the case 310 and it can be used for bearing one substrate S. It is easily understood that the cassette 300 for the present embodiment can include a plurality of conveying units for bearing a plurality of substrates S, as shown in FIG. 4B. Nevertheless, the cassette 300 with one conveying unit 320 of the embodiment herein is illustrated for simplicity

In the present embodiment, the conveying unit 320 includes a plurality of rollers 322 and a plurality of magnetic lead poles 324 wherein these rollers 322 are disposed in parallel for bearing the substrate S. In addition, each of the magnetic lead poles 324 is electrically connected to one terminal of the corresponding roller 322. When the magnetic lead pole 324 rotates, rotation of the corresponding roller 322 is driven so that the substrate S is moved. Briefly, in FIG. 4B, the substrates S are held, and moved out of the cassette 300 by the rollers 232 when necessary. Further, in more detail, the magnetic lead pole 324 can be perpendicular to the corresponding roller 322. It is worthy to note, though the conveying unit 320 of the present embodiment owns a plurality of magnetic lead poles 324, the substrate S can still be moved for the case that one single magnetic lead pole 324 is used.

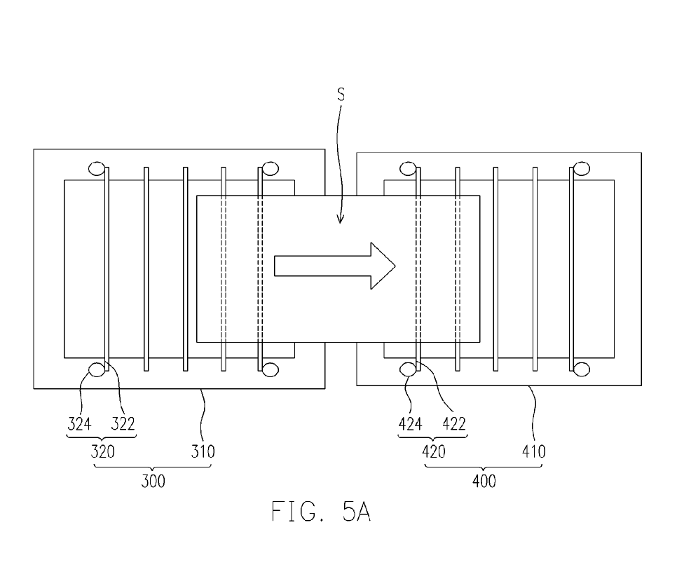

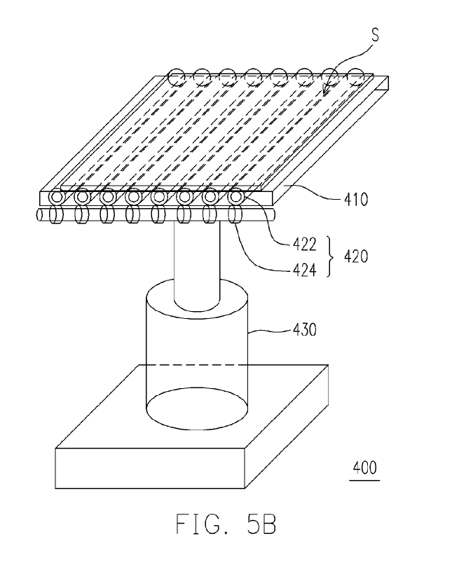

FIGS. 5A and 5B schematically show a top view and a three-dimensional view of a mechanical arm according to an embodiment of the present invention, respectively. The substrate S from the cassette 300 is then held and conveyed by a mechanical arm 400. The mechanical arm 400 includes a main body 410 and a conveying unit 420 where the conveying unit 420 is connected with the main body 410. Here, the conveying unit 420 can be identical to the conveying unit 320 of above-mentioned cassette 300, and it also includes a plurality of rollers 422 and a plurality of magnetic lead poles 424. Likewise, these rollers 422 are disposed in parallel for bearing and conveying the substrate S and each of the magnetic lead poles 424 is electrically connected to one terminal of the corresponding roller 422. The magnetic lead pole 424 can be perpendicular to the corresponding roller 422, for example. Additionally, it's worthy to note that, said main body 410 can be disposed on an adjusting substrate 430 which is suitably used for adjusting the vertical height of the conveying unit 420 so that the conveying unit 420 can hold the substrate S on the conveying unit 320 in the cassette 300 correspondingly, and for guiding the transmission direction of the substrate S.

In a word, in the conveying of the substrate S the mechanical arm 400 is to hold the substrate S sent from the conveying unit 320 of cassette 300. Later, by rotating the magnetic lead pole 424 of the conveying unit 400, the corresponding roller can be driven to rotate and thereby to move the substrate S. That is, the mechanical arm can be used to both hold and convey the substrate S.

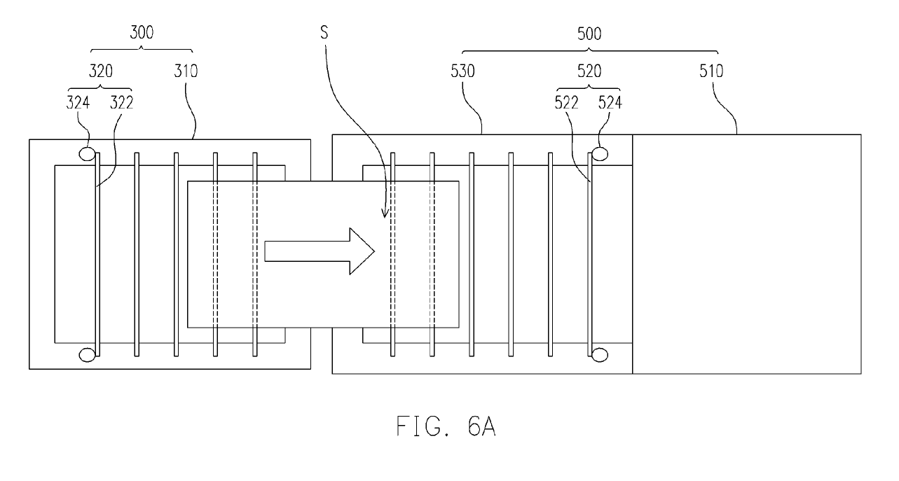

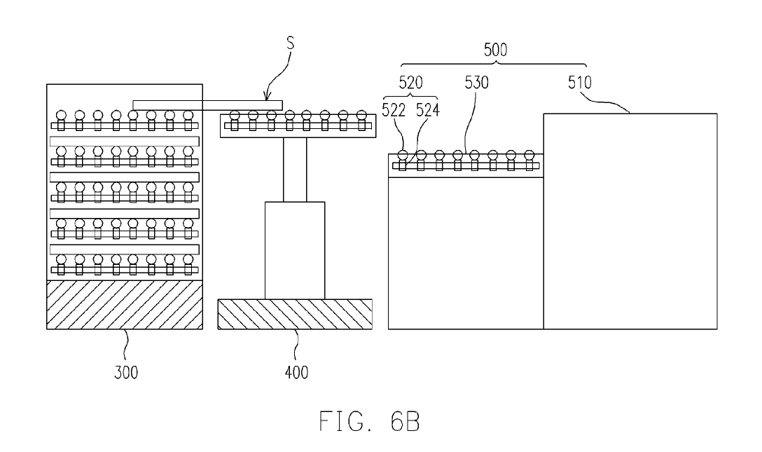

After that, the mechanical arm 400 conveys the substrate S into a process apparatus 500. FIG. 6A schematically shows a top view a process apparatus according to an embodiment of the present invention, and FIG. 6B schematically shows the usage of the cassette, the mechanical arm and the process apparatus according to the embodiments of the present invention simultaneously. Referring to FIG. 6A and 6B, the process apparatus 500 includes a reaction chamber 510, a conveying unit 520 and a loading/unloading chamber 530 where the loading/unloading chamber 530 and reaction chamber 510 are connected together. Besides, the conveying unit 520 and previously-mentioned conveying unit 320 can be still identical, and it also includes a plurality of rollers 522 and a plurality of magnetic lead poles 524. Wherein, the ways of disposing and electrical connection for those rollers 522 and the magnetic lead poles 524 are the same with those mentioned above and will not be repeated here.

Therefore, the substrate S held by the mechanical arm 400 is conveyed into the loading/unloading chamber 530, and later sent into the reaction chamber 510 by the conveying unit 520 for performing the semiconductor fabricating processes required. After the completion of processes, the substrate S is sent back to the cassette 300 for storing by sequential conveying of the conveying unit 520 and the mechanical arm 400. It can be seen that, by using the identical conveying units provided by the present invention, the operations of storing, conveying and fabricating process of the substrate can be sequentially performed.

It's also worthy to note here, in the present embodiment there is no limitation for the usage of the cassette 300, mechanical arm 400 and process apparatus 500 simultaneously. Otherwise, the cassette 300, mechanical arm 400 and process apparatus 500 can be employed separately.

To sum up, the present invention provides at least advantages as follows.

1. According to the present invent, the conveying units provided by combining the rollers and the magnetic lead poles are applied on the cassette, the mechanical arm and the process apparatus. Thus, the cassette, mechanical arm and process apparatus are capable of bearing the large-scale substrates.

2. Compared with the prior art, the cassette of the present invention can bear a larger amount of substrates and positioning of the mechanical arm of the present invention can be obviously simplified.

3. Compared with the prior art, damages of electronic devices caused by electro-static discharge can be prevented by utilizing the loading/unloading chamber with simplified design based on the present invention.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A cassette suitable for placing at least a substrate, comprising:
a case;
at least a conveying unit disposed inside the case, wherein the conveying unit comprising:
a plurality of rollers suitable for bearing the substrate; and
at least a magnetic lead pole electrically connected to one of the rollers, wherein rotation of a corresponding roller is driven to move the substrate when the magnetic lead pole rotates.

2. The cassette according to claim 1, wherein the magnetic lead pole is disposed in one end of the corresponding roller.

3. The cassette according to claim 1, wherein the magnetic lead pole is perpendicular to the corresponding roller.

4. The cassette according to claim 1, wherein the rollers are disposed in parallel.

5. A mechanical arm suitable for conveying a substrate, comprising:
a main body;
a conveying unit connected to the main body, wherein the conveying unit comprising:
a plurality of rollers suitable for bearing the substrate; and
at least a magnetic lead pole electrically connected to one of the rollers, wherein rotation of a corresponding roller is driven to move the substrate when the magnetic lead pole rotates.

6. The mechanical arm according to claim 5, wherein the magnetic lead pole is disposed in one end of the corresponding roller.

7. The mechanical arm according to claim 5, wherein the magnetic lead pole is perpendicular to the corresponding roller.

8. The mechanical arm according to claim 5, wherein the rollers are disposed in parallel.

9. A process apparatus suitable for providing a semiconductor process of a substrate, comprising:
a reaction chamber;
a loading/unloading chamber connected to the reaction chamber; and
a conveying unit disposed inside the loading/unloading chamber, wherein the conveying unit comprising:
a plurality of rollers suitable for bearing the substrate; and
at least a magnetic lead pole electrically connected to one of the rollers, wherein rotation of a corresponding roller is driven to move the substrate when the magnetic lead pole rotates.

10. The process apparatus according to claim 9, wherein the magnetic lead pole is disposed in one end of the corresponding roller.

11. The process apparatus according to claim 9, wherein the magnetic lead pole is perpendicular to the corresponding roller.

12. The process apparatus according to claim 9, wherein the rollers are disposed in parallel.
